(19) United States
(12) Patent Application Publication
(10) Pub. No.: US 2025/0037354 A1
(43) Pub. Date: Jan. 30, 2025

(54) GENERALIZABLE NOVEL VIEW SYNTHESIS GUIDED BY LOCAL ATTENTION MECHANISM

(71) Applicant: 1000786269 ONTARIO INC., Toronto (CA)

(72) Inventors: Yuanming Shu, Toronto (CA); Weiguang Ding, Toronto (CA)

(21) Appl. No.: 18/769,041

(22) Filed: Jul. 10, 2024

Related U.S. Application Data
(60) Provisional application No. 63/586,130, filed on Sep. 28, 2023.
(60) Provisional application No. 63/515,645, filed on Jul. 26, 2023.

(51) Int. Cl. G06T 15/20; G06T 7/50

(52) U.S. Cl. CPC G06T 15/20; G06T 7/50; G06T 2207/10032; G06T 2207/20084

(57) ABSTRACT

Methods and systems for novel view synthesis are provided. An example method involves accessing source images of a scene, encoding each source image into a series of multiscale feature maps, defining a target view for the scene, and decoding the target view into a target image of the scene, wherein the decoding involves applying global attention across the high level features of the multiscale feature maps of the source images, and applying local attention across a limited set of the lower level features of the multiscale feature maps of the source images.

### BACKGROUND

Novel view synthesis is a task in computer vision that involves generating images of a scene from arbitrary viewpoints based on a sparse collection of source images. A recent advancement in novel view synthesis is the development of neural radiance fields. This approach involves training a deep neural network to model the radiance of a scene as a continuous function in three-dimensional space. The trained neural network can generate highly realistic view-dependent images of a scene from arbitrary viewpoints. Applications of novel view synthesis may be found in various domains including virtual reality, augmented reality, three-dimensional scene reconstruction, the generation of digital twins, video compression, and more.

### BRIEF DESCRIPTION OF THE DRAWINGS

FIG. 1 is a schematic diagram of the architecture of an example machine learning model for novel view synthesis that follows an encoder-decoder architecture. The model includes a combination of a global attention mechanism and a local attention mechanism.

FIG. 2 is a schematic diagram of the architecture of another example machine learning model for novel view synthesis, following the architecture shown in FIG. 1, shown in greater detail.

FIG. 3 is a schematic diagram illustrating the operation of an example depth map feature projection process. The process may be used to guide a local attention mechanism of a machine learning model for novel view synthesis, such as in the machine learning models of FIG. 1 and FIG. 2.

FIG. 4 is a schematic diagram of an example system for novel view synthesis delivered in the form of a centralized server and/or platform accessible by a plurality of client devices.

FIG. 5 is a schematic diagram of an example system for novel view synthesis delivered locally through a user device.

FIG. 6 is a flowchart of an example method for novel view synthesis.

### DETAILED DESCRIPTION

Significant advancements have been made in the field of novel view synthesis in recent years with the introduction of Neural Radiance Fields (NeRF) (Mildenhall, Ben, et al. “Nerf: Representing scenes as neural radiance fields for view synthesis.” Communications of the ACM 65.1 (2021): 99-106). As originally proposed, the NeRF technique involves overfitting a neural network to a collection of source images depicting an individual scene. Although the resulting neural network can be used to recreate highly realistic novel views of the scene, the training process requires a large number of source images, a long per-scene optimization, and the resulting neural network can only be used to generate views of a single scene.

Follow-on works, including Multi-View Stereo NeRF (MVSNeRF) (Chen, Anpei, et al. “Mvsnerf: Fast generalizable radiance field reconstruction from multi-view stereo.” Proceedings of the IEEE/CVF International Conference on Computer Vision. 2021), have achieved good generalizability across scenes, with faster optimization time, on fewer input source images. However, the MVSNeRF technique requires building a dense 3D neural encoding volume for each scene, which is costly to maintain at scale.

In contrast to the original NeRF approach, this disclosure proposes an encoder-decoder architecture that is generalizable across scenes. Further, in contrast to MVSNeRF, this disclosure proposes to drop the 3D neural encoding volume entirely, relying solely on the 2D neural features encoded from the source images to decode a target image from a novel viewpoint. In this approach, three-dimensional detail is captured at the decoder through a series of attention mechanisms that includes a local attention mechanism, which can involve a depth map feature projection process. This process not only captures the three-dimensional structure of the scene but also limits the number of features required for the attention calculations. In this way, the proposed model is capable of capturing the most relevant neural features directly from the encoded 2D feature maps derived from the source images, in a manner that incorporates the three-dimensional structure of the scene, and in a process that is generalizable, and efficient at scale.

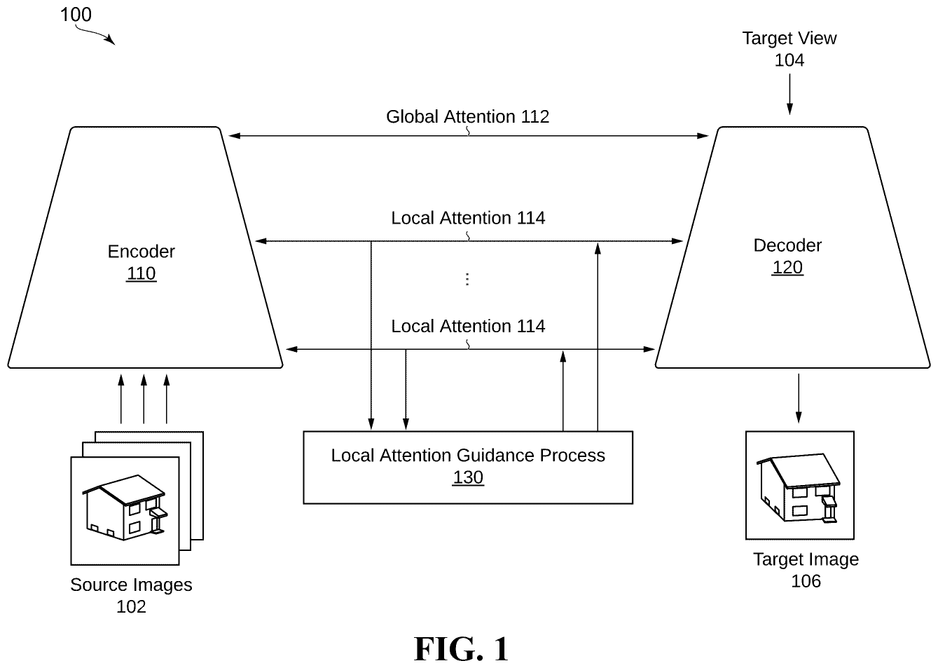

The architecture of the proposed model is illustrated at a high level in FIG. 1. As shown in FIG. 1, a machine learning model 100 for novel view synthesis comprises an encoder 110 and a decoder 120 in a deep learning architecture. The decoder 120 applies attention over the encoder 110 through at least one global attention mechanism 112 and one or more local attention mechanisms 114, which will be described in greater detail below.

The encoder 110 is configured to process a plurality of source images 102 from multiple points of view, which depict some arbitrary scene to be modeled, to generate a respective feature map for each of the source images 102. The encoder 110 comprises some series of encoder layers, omitted here for simplicity, that progressively encode each source image 102 into a series of intermediate feature representations, which tend to increase in number of channels and decrease in resolution, and which collectively may be referred to as a series of multiscale feature maps. For example, if a source image 102 is an aerial image captured at native ground resolution 0.25 m, the series of multiscale feature maps may correspond to features extracted at 0.25 m, 0.5 m, and 1.0 m resolutions. The series of multiscale feature maps for each source image 102 culminates in what will be referred to herein as a final feature map for the source image 102. This series of multiscale feature maps is generated for each source image 102.

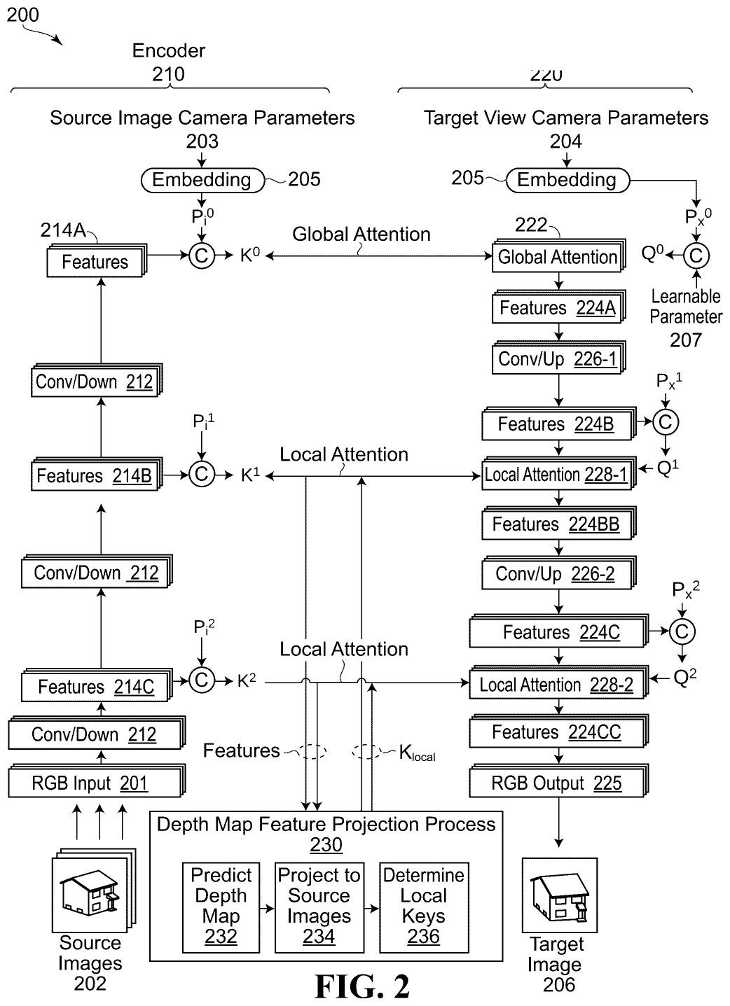

The series of encoder layers may include one or more convolutional layers, one or more self-attention layers, one or more feed-forward neural layers, or any other suitable encoding layers capable of extracting and encoding key features from the source images 102, with downsampling layers as appropriate. The encoder 110 may further include an embedding component that embeds the camera parameters for the source images 102. These camera parameters refer to the parameters used in a camera model to describe the mathematical relationship between the 3D coordinates of a point in the scene to the 2D coordinates of its projection onto an image plane (whether according to a pinhole camera model, pushbroom camera model, fisheye camera model, or other camera model). Further, it should be understood that one or more blocks of such components may be arranged in a deep learning architecture. A more detailed description of one example architecture is described in FIG. 2, further below.

Turning to the decoder 120, the decoder 120 is configured to decode a representation of a target view 104, which describes some arbitrary pose relative to the scene, into a target image 106 of the scene. The decoder 120 comprises some series of decoder layers, omitted here for simplicity, that progressively decode a representation of the target view 104 into a series of intermediate feature representations, which tend to decrease in the number of channels and increase in resolution, and which may be referred to as a series of multiscale feature maps. In keeping with the above example of an aerial image captured at native ground resolution 0.25 m, the series of multiscale feature maps may correspond to features decoded at 1.0 m, 0.5 m, and 0.25 m resolutions. The series of multiscale feature maps for each target view 104 culminates in what will be referred to herein as a final feature map, from which the pixel colors for the target image 106 can be determined (e.g., by some final activation function).

It should also be noted that the camera parameters that define the target view 104 need not necessarily match the same camera model used to capture the source images 102. For example, the source images 102 may have been captured through a fisheye camera model, whereas the target view 104 may call for a pinhole camera model. Therefore, the machine learning model 100 may be used to generate target images 106 with a preferred camera model for the scene.

The series of decoding layers may include one or more convolutional layers, one or more self-attention layers, one or more feed-forward neural layers, or any other suitable decoding layers capable of decoding key features for the target image 106, with upsampling layers as appropriate. The decoder 120 may further include an embedding component that embeds camera parameters for the target view.

Notably, the decoder 120 includes at least one global attention layer, which gives rise to the global attention mechanism 112, and one or more local attention layers, each of which gives rise to a respective local attention mechanism 114. It is through these cross-attention mechanisms that the features of the target image 106 are progressively decoded by attending to feature information encoded from the source images 102.

Further, it should be understood that one or more blocks of the above components may be arranged in a deep learning architecture. A more detailed description of one example architecture is described in FIG. 2, further below.

As mentioned above, the decoder 120 applies attention over the encoder 110 through at least one global attention mechanism 112 and one or more local attention mechanisms 114. The global attention mechanism 112 is applied at or near the top of the decoder 120, to attend to the higher-level (i.e., lower resolution) features at the encoder 110, where an attention calculation is relatively inexpensive. Since global attention is applied at the top of the decoder 120, the global attention mechanism 112 applies attention over each feature of the final encoded feature map for each source image 102.

However, further down the decoder 120, to attend to the lower-level (i.e., higher resolution) features at the encoder 110, where attention calculations are more expensive, the decoder 120 applies a form of local attention that reduces the computational resources required, indicated here as the local attention mechanisms 114. These local attention mechanisms 114 are guided by a local attention guidance process 130 which incorporates an understanding of the spatial (i.e., topographical or geometric) features of the scene. This understanding not only captures the three-dimensional structure of the scene, but also limits the number of features to which the local attention mechanism 114 attends, thereby improving computational efficiency. One example of such a local attention guidance process 130 is the depth map feature projection process, described in FIG. 2, further below.

In terms of training, the machine learning model 100 may be trained on a dataset comprising a plurality of sets of source images 102 depicting a plurality of scenes, for generalizability. In terms of the objective function, the machine learning model 100 may be trained solely on image loss. The training process would typically involve selecting some of the images of each scene to serve as the ground truth images against which the synthesized images are measured to determine image loss. Therefore, the machine learning model 100 is trained end-to-end in a self-supervised manner without the need for annotated training data. Furthermore, the encoder 110 and decoder 120 may thereby learn to encode the features of the source images 102 and decode a target image 106 without being tied to the structure of any given scene.

The depth map generation process need not be trained separately, and may be learned implicitly as part of decoding the target image 106. Therefore, the depth map generation process is trained implicitly as part of a self-supervised training process, also without the need for annotated training data.

The machine learning model 100, including the trained learned neural network weights, biases, activation functions, and other architectural components and functionality, may be embodied in non-transitory machine-readable programming instructions, and executable by one or more processors of one or more computing devices, which include memory to store programming instructions that embody the functionality described herein and one or more processor to execute the programming instructions.

As mentioned above, a more detailed example of the architecture of the proposed model is provided in FIG. 2.

In FIG. 2, a machine learning model 200 of FIG. 2 comprises an encoder 210 and a decoder 220 in a deep learning architecture.

As above, the encoder 210 is configured to process each source image 202 through a series of convolutional layers 212 into a series of progressively encoded feature maps at multiple scales. In the present example, the encoder 210 includes three sets of convolutional and downsampling layers (indicated as conv/down layers 212), which produce two intermediate encoded feature maps 214C and 214B followed by a final encoded feature map 214A. For example, if the source images 202 include aerial images captured at native ground resolution 0.25 m, the features 214C may correspond to the highest-resolution 0.25 m features, whereas the features 214B may correspond to the lower-resolution 0.5 m features, and the features 214C may correspond to the lowest-resolution 1.0 m features. It should be noted that each convolutional layer may be applied in accordance with any known techniques, including the use of several convolutional layers of varying kernel size, and that each downsampling layer may be applied in accordance with any known techniques.

It should also be noted that whereas the raw pixel data of the source images 202, indicated here as RGB input 201, flow through the conv/down layers 212, the corresponding camera parameters for each source image 202, indicated here as source image camera parameters 203, are embedded and used to form part of the key matrix in the following attention calculations. Each set of source image camera parameters 203 is passed through embedding layer 205, resulting in an embedded representation of each corresponding source view, indicated here as Pᵢ⁰, where i denotes a source image 202, and where 0 indicates that Pᵢ⁰ represents the camera parameter embeddings added at the final stage of encoding. For each source image 202, the camera parameter embedding Pᵢ⁰ is concatenated with its corresponding final encoded feature map 214A to form a key matrix, indicated here as K⁰, which will be used in the global attention calculation at the decoder 220, as described further below. The embedding layer 205 may be specialized to the type of camera model being used (e.g., pinhole, pushbroom, or fisheye), or may be generalized for any camera model.

Turning to the decoder 220, as above, the decoder 220 is configured to decode a representation of a target view, which describes some arbitrary pose and projection parameters relative to the scene (i.e., camera parameters), to decode a target image 206 of the scene. The decoder 220 decodes this target view through a series of convolutional and upsampling layers situated between attention layers. In keeping with the above example of the source images 202 including aerial images captured at native ground resolution 0.25 m, the decoded features may be progressively decoded through 1.0 m, 0.5 m, and 0.25 m resolutions.

In the present example, the representation of the target view comprises a set of target view camera parameters 204, passed through embedding layer 205 (similar or identical to the embedding layer 205 at the encoder 210), resulting in a camera parameter embedding Pₓ⁰, where x denotes the target view. The resulting camera parameter embedding Pₓ⁰ is concatenated with a learnable parameter 207, to form a query Q⁰, that will be used in the global attention calculation, as described below.

The first layer of the decoder 220 comprises a global attention layer 222. The global attention layer 222 computes attention based on Q⁰, derived from the target view as described above, and K⁰, derived from the source images 202 as described earlier in this disclosure. Attention may be computed in any suitable manner, such as performing scaled dot product between cross-attention values (see, e.g., Attention may be computed as described in Vaswani, Ashish, et al. “Attention is all you need.” Advances in neural information processing systems 30 (2017)). At this stage, the global attention layer 222 attends to all of the features of all of the final encoded feature maps 214A of all of the source images 202 to produce an initial decoded feature map 224A (e.g., 1.0 m resolution features). At this stage in the decoding process, a global attention calculation is relatively inexpensive, and therefore is justifiable so that the target image 206 can be decoded with the benefit of attention applied globally across the source images 202.

Following the global attention layer 222, the initial decoded feature map 224A is further processed by a first convolutional layer and upsampling layer (indicated as conv/up 226-1) to produce a further decoded feature map 224B (e.g., 0.5 m resolution features). The feature map 224B is further processed by a first local attention layer 228-1. The first local attention layer 228-1 computes attention based on Q¹, a query derived from concatenating the previously decoded feature map 224B with an embedded representation of the target view, indicated here as Pₓ¹ and with a key matrix denoted as K¹, which corresponds to a limited set of features selected from the encoder 210, concatenated with an embedded representation of the corresponding source view. The limited set of features to which the first local attention layer 228-1 attends is determined by a depth map feature projection process 230, described below.

It should be noted at this stage that each successive query (i.e., Q⁰, Q¹, Q²) may be derived based on the original query and upsampled to the increased resolution of the larger dimension feature map. For example, Q¹ can be derived by upsampling Q⁰ for feature map 224B. Conversely, each successive key (i.e., K⁰, K¹, K²) at the encoder 210 matches the resolution of the corresponding feature map.

The depth map feature projection process 230 involves generating a depth map at an intermediate stage of the decoding process, and using the depth map to capture three-dimensional information, and to narrow the set of features involved in the attention calculations at the decoder 220. The depth map feature projection process 230 involves three major steps for determining the limited set of features to which a local attention layer 228 attends. Applying the depth map feature projection process does not alter the scale of the decoded features, but rather, fills in the detail (with reference to the source image feature maps) missing from the previously upsampled feature map.

First, at step 232, a depth map for the scene is predicted based on an intermediate decoded feature map that precedes the local attention layer. For example, in the case of determining the limited set of features to which the local attention layer 228-1 attends, the immediately preceding feature map 224B is used to generate a depth map. The depth map may be generated by any suitable technique for generating depth maps based on a feature map extracted from an image. For example, the depth map may be generated through a series of convolutional layers and/or other neural layers. The resolution of the depth map may correspond to the scale of the features from which it was derived (e.g., 0.5 m in the case of attention layer 228-1).

Second, at step 234, for each feature of the feature map used to predict the depth map, the corresponding point on the depth map is projected onto each intermediate encoded feature map, for each source image, of the corresponding scale (e.g., 0.5 m). For example, in the case of local attention layer 228-1, for each feature of the feature map 224B, a corresponding point on the depth map is projected onto the feature map 214B for each source image 202. In some cases, projection may fail, for example, where a point on the depth map cannot be geometrically projected to the image plane of a source image 202. In such a case, the attention calculation will be limited to the features of the remaining source images 202 to which projection is geometrically possible.

It should also be noted that, in some cases, the projection of a point on the depth map to a source image 202 may be occluded by another section of the depth map. In some implementations, this occlusion may be automatically detected, and the occluded source image 202 may be excluded from the local attention calculation. However, in other implementations, it is expected that the model may learn to implicitly account for such occlusions, and to generate a low attention score for the features of the occluded source image 202, without the need for a separate process to handle the occlusion.

Third, at step 236, each feature on the source image feature maps to which a point on the depth map was projected is selected to be included in the limited set of features to which the local attention layer attends. For example, in the case of local attention layer 228-1, each feature on the feature map 214B, of each source image 202, to which a point on the depth map was projected, is attended to by the local attention layer 228-1. The resulting attention calculation produces the next intermediate decoded feature map 224BB.

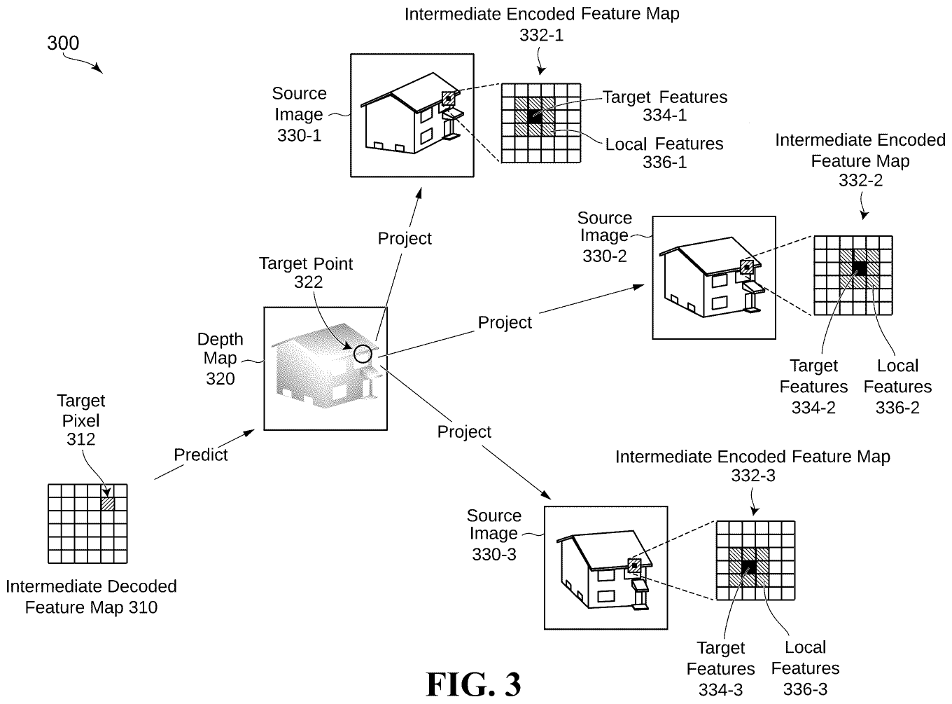

This depth map feature projection process is illustrated for greater clarity with respect to a single pixel in FIG. 3.

In FIG. 3, a depth map feature projection process 300 begins with a target pixel 312 of an intermediate decoded feature map 310 of any suitable resolution (e.g., 0.5 m).

First, a depth map 320 is predicted based on the intermediate decoded feature map 310, by any suitable technique. The scale of the generated depth map 320 corresponds to the scale of the intermediate decoded feature map 310 (e.g., 0.5 m). The point on the depth map 320 that corresponds to the pixel 312 of the intermediate decoded feature map is indicated as target point 322. The depth map 320 is illustrated in a monochromatic gradient to represent the depth of the surface structure of the scene. Areas of the depth map 320 that appear darker should be understood to be further away from the camera, whereas areas of the depth map 320 that appear lighter should be understood to be closer to the camera.

Next, the target point 322 is projected back to each source image 330 (i.e., source image 330-1, 330-2, and 330-3), or, more precisely, back to the corresponding feature maps (e.g., 0.5 m feature map) thereof. Thus, the target point 322 is projected to the intermediate encoded feature map 332-1 derived from the source image 330-1, to the intermediate encoded feature map 332-2 derived from the source image 330-2, and to the intermediate encoded feature map 332-3 derived from source image 330-3.

Finally, a limited set of features selected from the intermediate encoded feature maps 332-1, 332-2, and 332-3, based on the projection of the target point 322, is selected. This limited set of features will be used in the relevant local attention mechanism. In an extreme case, only the precise features onto which the target point 322 was projected may be included in the selection (indicated as target features 334-1, 334-2, 334-3). However, this selection may be overly narrow, and may miss important information surrounding the feature to which the point 322 was projected. Preferably, a small selection of surrounding features may also be included in the attention calculation. For example, the set of directly adjacent features (indicated here as the local features 336-1, 336-2, and 336-3, for each source image 332-1, 332-2, and 332-3, respectively) may also be included in the local attention calculation. In other cases, even larger sets of local features may be included (e.g., features within two or three spaces of the projected feature), as computational resources permit.

Although depicted for illustrative purposes for a single target pixel 312, it is to be understood that the depth map feature projection process 300 is to be repeated for each pixel of the intermediate decoded feature map 310.

Returning back to FIG. 2, the local attention layer 228-1 produces the further decoded feature map 224BB based on the previous decoded feature map 224B with attention to the limited set of features selected from the encoded feature map 214B, through a depth map feature projection process, as described above.

The feature map 224BB is further processed by a second convolutional layer and upsampling layer (indicated as conv/up 226-2) to produce feature map 224C, which is in turn processed by a second local attention layer 228-2. As with the first local attention layer 228-1, the second local attention layer 228-2 computes attention based on Q², a query derived from concatenating the previously decoded feature map 224C with an embedded representation of the target view, indicated here as Pₓ² and a key matrix denoted as K², a limited set of features selected from the encoder 210 in accordance with the depth map feature projection process 230, concatenated with embedding camera parameters for the corresponding source view. The second local attention layer 228-2 produces the final decoded feature map 224CC. Finally, the decoder 220 applies a final activation function, such as the Softmax function, to classify the features of the final decoded feature map 224CC into image pixels, indicated here as RGB output 225.

Thus, the target image 206 is decoded from the target view camera parameters 204, drawing feature information from the encoder 210 through a global attention layer 222 and two local attention layers 228-1, 228-2, at multiple scales. However, it should be understood that the model 200 is simplified for illustrative purposes, and that in practice, additional layers (corresponding to higher or lower resolutions) may be used. For example, the decoder 220 may include two or more global attention layers (at or near the top of the decoder 220), the decoder 220 may include several more local attention layers (toward the bottom of the decoder 220), and the encoder 210 may include several more convolutional layers.

In general, each attention layer at the decoder 220 corresponds to the layer of feature maps at the encoder 210 of matching feature resolution. However, in some cases, an attention layer may be configured to attend to a feature map higher or lower in the encoder 210 that may not match in resolution. Further, in some cases, an attention layer may be configured to attend to multiple layers of feature maps up and down the encoder 210, if computational resources permit.

As mentioned above with regard to FIG. 1, the machine learning model 200 of FIG. 2 may be trained on a diverse range of scenes and may be made generalizable across scenes. The machine learning model 200 may be trained solely on image loss (e.g., L2 rendering loss), with the capability to decode the three-dimensional structure of a scene as an intermediate process, drawing solely from the two-dimensional features extracted from the source images 202.

Further, the machine learning model 200, including the trained learned neural network weights, biases, activation functions, and other architectural components and functionality, may be embodied in non-transitory machine-readable programming instructions, and executable by one or more processors of one or more computing devices, which include memory to store programming instructions that embody the functionality described herein and one or more processor to execute the programming instructions.

In terms of applications, the machine learning models described above may be applied in any use case for novel view synthesis, including, for example, novel view synthesis of objects, interior scenes, exterior scenes, even including large outdoor scenes comprising large structures such as buildings, roads, and landscapes. Indeed, the computational efficiency achieved through the use of the local attention mechanism described herein lends itself to modeling large scenes with sufficient computational resources and/or efficiently modeling smaller scenes where less computational resources are available.

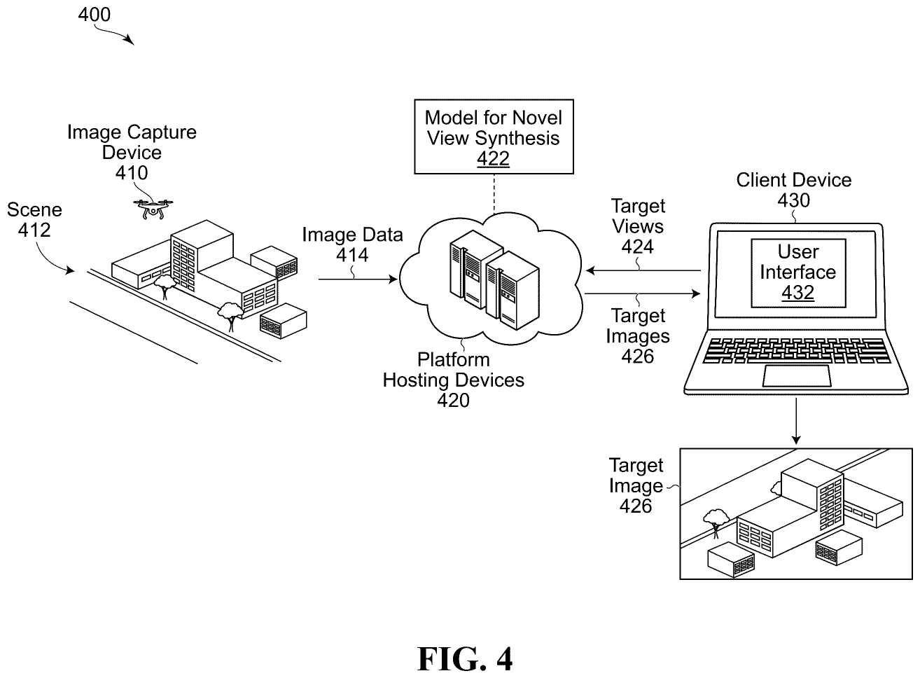

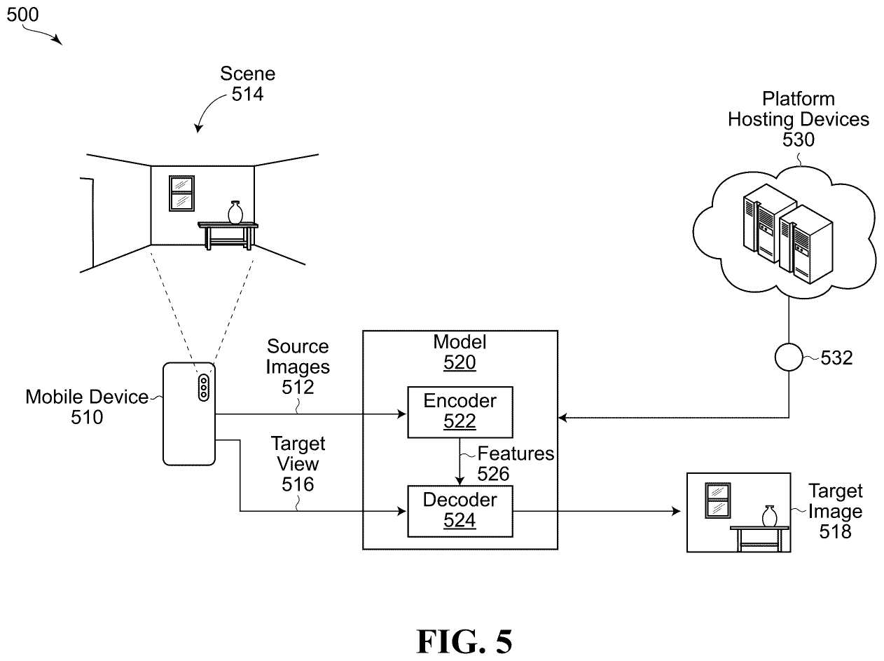

Further, the novel view synthesis described herein may be delivered to end users in a variety of ways. As one example, several source images of a scene may be collected and processed at a central server system to which requests for novel views of the scene may be made by a plurality of client users (e.g., FIG. 4, below). As another example, a user device may store a local copy of the model which was pre-trained on a large dataset and then deployed to the user device (FIG. 5, below).

These example implementation scenarios are described for illustrative purposes in further detail below.

FIG. 4 is a schematic diagram of an example system 400 for novel view synthesis involving the methods described herein delivered in the form of a centralized server and/or platform accessible by a plurality of client devices. The present example is applied to an outdoor scene containing a group of buildings which are to be modeled.

The system 400 includes one or more image capture devices 410 to capture image data 414 of a scene 412 containing a building. An image capture device 410 may include any suitable sensor (e.g., camera) onboard a satellite, aircraft, drone, observation balloon, or other device capable of capturing imagery of the scene 412 (e.g., smartphone). In the present example, the image capture device 410 is depicted as a camera onboard a drone, which may be capable of capturing several source images of the scene 412 from several points of view.

The image data 414 may comprise the raw image data captured by such image capture devices 410 along with any relevant metadata, including camera parameters (e.g., focal length, lens distortion, camera pose, resolution), geospatial projection information (e.g., latitude and longitude position), or other relevant metadata. The image data 414 may contain one or several batches of imagery covering the area, which may have been captured on the same dates or on different dates.

The system 400 further includes one or more platform hosting devices 420 to process the image data 414 as described herein to generate target images 426. The platform hosting devices 420 include one or more computing devices, such as virtual machines or servers in a cloud computing environment comprising one or more processors for executing computing instructions. In addition to processing capabilities, the platform hosting devices 420 include one or more communication interfaces to receive/obtain/access the image data 414 and to output/transmit target images 426 through one or more computing networks and/or telecommunications networks such as the internet. Such computing devices further include memory (i.e., non-transitory machine-readable storage media) to store programming instructions that embody the functionality described herein.

The platform hosting devices 420 are configured to run (i.e., store, host or access) a model for novel view synthesis 422, which represents one or more programs, software modules, or other set of non-transitory machine-readable instructions, configured to process the image data 414 to produce a model capable of synthesizing target images 426 upon request given corresponding target views 424. The model for novel view synthesis 422 may be similar to the model 100 of FIG. 1 or the model 200 of FIG. 2, or any suitable variation thereof, capable of synthesizing views of the scene 412 given a target set of camera parameters.

The platform hosting devices 420 are also configured to run (i.e., store, host or access) a platform capable of receiving requests for target views 424 from one or more client devices 430, and in turn delivering such target images 426 to the client devices 430 in response to such requests. The platform may be made accessible through an Application Programming Interface (API) or through a user interface accessible through a web browser, mobile application, or other means.

A client device 430 may include one or more computing devices configured to run (i.e., store, host or access) one or more software programs to display, process, or otherwise use the target images 426 (e.g., a platform provided by platform hosting devices 420). A client device 430 may include a display device that displays a user interface 432 through which a user may view the target images 426.

In operation, the platform hosting devices 420 may train the model for novel view synthesis 422 on a large dataset of imagery comprising a wide range of scenes. After training, the platform hosting devices 420 may service requests for target images 426 of those scenes. In some cases, the platform hosting devices 420 may also receive new batches of source images from client devices 430 depicting new scenes, and may service requests to synthesize novel views of those scenes as well. In other words, the platform hosting devices 420 may access new source imagery (i.e., similar to image data 414) contributed directly from the client devices 430 themselves. The platform hosting devices 420 may thereby be continually trained on new scenes as new source imagery is contributed.

Although the centralized model described in FIG. 4 above may offer particularly powerful computational resources and training capability, in some cases, a more distributed approach may be desired. For example, a scaled-down version of the model for novel view synthesis may be deployed on a smaller-scale user device, as shown in FIG. 5.

FIG. 5 is a schematic diagram of an example system 500 for novel view synthesis involving the methods described herein delivered in the form of a user device pre-loaded with a pre-trained model for novel view synthesis. The present example is also applied to an indoor scene in which the contents of a small room are to be modeled.

The system 500 includes a mobile device 510 configured to capture source images and synthesize novel views of a scene 514. The mobile device 510 may include any suitable device capable of capturing imagery and with appropriate memory, processing, and communication capabilities (e.g., smartphone, tablet, laptop computer, or other smart device).

The mobile device 510 is configured to run model 520 for novel view synthesis, which is shown here broken down into an encoder 522 and decoder 524. The model 520 may be similar to those described in FIG. 1 and/or FIG. 2 and is pre-trained for novel view synthesis. The model 520 may have been transmitted to the mobile device 510 as a data package 532 by platform hosting devices 530 (e.g., similar to the platform hosting devices 420 of FIG. 4). The mobile device 510 may also be loaded with a software program with a user interface through which a user may capture source images of the scene 514 and execute the model 520.

In operation, a user of the mobile device 510 captures a set of source images 512 of the scene 514. The set of source images 512 may be sparse but should provide sufficient coverage of the scene 514 to enable novel view synthesis. The encoder 522 encodes the source images 512 into features 526 which can then be decoded by the decoder 524 for any arbitrary viewpoint. The decoder 524 receives a target view 516 (e.g., by user control of a user interface) for a particular set of camera parameters that is decoded into a target image 518, drawing on the relevant features 526 of the source images 512 as necessary to synthesize the novel view. Since the features 526 to which the decoder 524 attends to decode the target image 518 are only two-dimensional, and since the decoding process can be made more efficient by the local attention process described in this disclosure, the decoding process may require relatively little processing resources, capable of being executed locally on the mobile device 510.

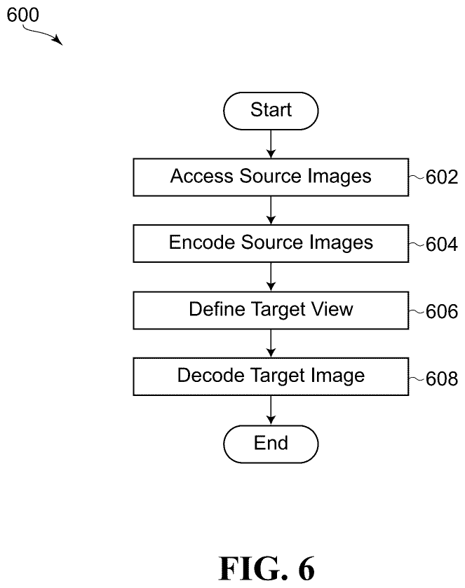

FIG. 6 is a flowchart of an example method 600 for novel view synthesis that summarizes the techniques described above. The step of method 600 may be organized into one or more functional processes and embodied in non-transitory machine-readable programming instructions executable by one or more processors in any suitable configuration, including the computing devices of the systems described here.

The method 600 involves, at step 602, accessing a plurality of source images of a scene. At step 604, an encoder encodes each source image into a final encoded feature map preceded by a series of intermediate encoded feature maps at multiple scales. At step 606, a representation of a target view from which the scene is to be synthesized is defined. At step 608, a decoder decodes the representation of the target view into a target image comprising a novel view of the scene. The decoding involves, as described above, applying a global attention layer that attends to the features of the final encoded feature maps of the source images. The decoding further involves, as described above, applying a local attention layer that attends to only a limited set of features selected from one or more intermediate encoded feature maps of one or more source images based on a depth map feature projection process.

The depth map feature projection process involves predicting, based on an intermediate decoded feature map that precedes the local attention layer, a depth map for the scene. The process further involves, for each feature of the intermediate decoded feature map used to predict the depth map, determining a point on the depth map that corresponds to that feature, and attempting to project that point on the depth map onto each intermediate encoded feature map for each source image at a corresponding scale at the encoder. The process further involves selecting a set of features to which the point on the depth map was projected, to be included in the limited set of features to which the local attention layer attends.

It should be recognized that features and aspects of the various examples provided above can be combined into further examples that also fall within the scope of the present disclosure. The scope of the claims should not be limited by the above examples but should be given the broadest interpretation consistent with the description as a whole.

1. A method comprising:
accessing source images of a scene;
encoding each source image into a series of multiscale feature maps;
defining a target view for the scene; and
decoding the target view into a target image of the scene, wherein the decoding involves:
applying global attention across a set of higher-level features of the multiscale feature maps of the source images; and
applying local attention across limited sets of lower-level features of the multiscale feature maps of the source images.

2. The method of claim 1, further comprising performing a depth map feature projection process to determine a limited set of lower-level features for the local attention.

3. The method of claim 2, wherein the depth map feature projection process comprises:
generating a depth map for the scene for the target view;
projecting a point on the depth map back to at least a subset of the source images; and
selecting a set of features of the source images to which the point was projected to be included in the local attention.

4. The method of claim 1, wherein the decoding comprises applying a convolutional layer between the global attention and the local attention.

5. The method of claim 1, wherein the source images comprise one or more aerial images of the scene.

6. The method of claim 1, wherein the source images comprise one or more images captured by a mobile device.

7. The method of claim 1, wherein the scene comprises an outdoor scene depicting at least one building.

8. The method of claim 1, wherein the scene comprises an interior scene depicting at least one object.

9. A method for novel view synthesis, the method comprising:
accessing a plurality of source images of a scene;
at an encoder, encoding each source image into a series of multiscale feature maps including a series of intermediate encoded feature maps followed by a final encoded feature map;
defining a representation of a target view from which the scene is to be synthesized; and
at a decoder, decoding the representation of the target view into a target image comprising a novel view of the scene, wherein the decoding involves:
applying a global attention layer that attends to all of the features of all of the final encoded feature maps of all of the source images; and
applying a local attention layer that attends to only a limited set of features selected from one or more intermediate encoded feature maps of one or more source images based on a depth map feature projection process.

10. The method of claim 9, wherein:
the decoding involves decoding the representation of the target view into a series of multiscale feature maps including a series of intermediate decoded feature maps followed by a final decoded feature map;
the local attention layer corresponds to a set of intermediate encoded feature maps for each source image at a corresponding scale; and
applying the local attention layer comprises:
predicting, based on an intermediate decoded feature map corresponding to and preceding the local attention layer, a depth map for the scene;
for each feature of the intermediate decoded feature map used to predict the depth map, determining a point on the depth map that corresponds to that feature, and attempting to project that point on the depth map onto each intermediate encoded feature map for each source image at the corresponding scale; and
selecting each feature to which the point on the depth map was projected to be included in the limited set of features to which the local attention layer attends.

11. The method of claim 10, wherein the limited set of features to which the local attention layer attends further includes, for each feature to which the point on the depth map was projected, a set of surrounding features.

12. The method of claim 9, wherein:
the global attention layer computes attention based on:
a query comprising an embedded representation of a set of camera parameters for the target view concatenated with a learnable parameter, and
a key corresponding to each of the features of each of the final encoded feature maps of each of the source images each concatenated with an embedded representation of a set of camera parameters for a corresponding source image; and
the local attention layer computes attention based on:
a query comprising an intermediate decoded feature map that precedes the local attention layer, concatenated with an embedded representation of a set of camera parameters for the target view, and
a key corresponding to a limited set of features to which the local attention layer attends for a plurality of source images each concatenated with an embedded representation of a set of camera parameters for the corresponding source image.

13. The method of claim 9, wherein the decoding further comprises applying one or more convolutional layers between the global attention layer and the local attention layer.

14. The method of claim 13, wherein the decoding comprises applying additional sets of alternating convolutional layers and local attention layers.

15. The method of claim 9, wherein:
the decoding involves decoding the representation of the target view into a series of multiscale feature maps including a series of intermediate decoded feature maps followed by a final decoded feature map; and
the decoding involves applying a final activation function to classify the features of the final decoded feature map into image pixels.

16. The method of claim 9, wherein the decoding comprises:
applying a global attention layer that attends to all of the features of all of the final encoded feature maps of all of the source images to decode a first intermediate decoded feature map for the target image;
applying one or more convolutional layers, following the global attention layer, to decode a second intermediate decoded feature map for the target image; and
applying a local attention layer, following the one or more convolutional layers, to decode a third intermediate decoded feature map for the target image, wherein the local attention layer attends to only a limited set of features selected from one or more intermediate encoded feature maps of corresponding scale of one or more source images based on a depth map feature projection process.

17. A system comprising one or more computing devices configured to:
access source images of a scene;
encode each source image into a series of multiscale feature maps;
define a target view for the scene; and
decode the target view into a target image of the scene, wherein the decoding involves:
applying global attention across a set of higher-level features of the multiscale feature maps of the source images; and
applying local attention across limited sets of lower-level features of the multiscale feature maps of the source images.

18-20. (canceled)
